(19) United States
(12) Patent Application Publication
(10) Pub. No.: US 2010/0081477 A1
(43) Pub. Date: Apr. 1, 2010

(54) PORTABLE DEVICE DISPLAY PRESENTING TWO AND THREE DIMENSIONAL IMAGES

(75) Inventors: Bernard F. Coll, Fountain Hills, AZ (US); Kenneth Dean, Phoenix, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 12/241,359

(22) Filed: Sep. 30, 2008

(51) Int. Cl. H04M 1/00

(52) U.S. Cl. 455/566

(57) ABSTRACT

An electronic device (100, 400, 500) includes a display (116, 516) positioned within a housing (104, 504) for presenting two dimensional images. A cover (102, 502) is moveably mounted to the housing (104, 504) and capable of assuming an open position and a closed position. An optical element (120, 420, 520) is disposed within the cover (102, 502), wherein the display (116, 516) may be viewed directly when the cover (102, 502) is in the open position and wherein the display may be viewed through the optical element (120, 420, 520) when the cover (102, 502) is in the closed position, the optical element (120, 420, 520) giving the two dimensional images on the display (116, 516) a three dimensional appearance.

### FIELD

The present invention generally relates to portable electronic devices and more particularly to a method and apparatus for displaying images in a clamshell device such as a flip phone.

### BACKGROUND

The market for personal portable electronic devices, for example, cell phones, laptop computers, personal digital assistants (PDAs), digital cameras, and music playback devices (MP3), is very competitive. Manufacturers, distributors, service providers, and third party providers have all attempted to find features that appeal to the consumer. Manufacturers are constantly improving their product with each model in the hopes it will appeal to the consumer more than a competitor's product. Many times these manufacturer's improvements do not relate directly to the functionality of the product.

The look and feel of personal portable electronics devices is now a key product differentiator and one of the most significant reasons that consumers choose specific models. From a business standpoint, outstanding designs (form and appearance) may increase market share and margin.

Larger and more colorful displays with higher resolution have become a large factor driving consumer's choice of product. Any improvement in the display may have a large affect on consumer demand. Presentation of a three dimensional image from a display has previously been disclosed, for example, in U.S. Pat. No. 6,069,650; however, in order to transition from a two dimensional image to a three dimensional image, an electronic circuit including additional layers embedded within the optical element are required. This additional circuitry and layers increases cost and complexity.

Accordingly, it is desirable to provide a simple, low cost apparatus and method for providing perceived three dimensional images on an electronic device. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIG. 1 is a top view of a first exemplary embodiment of a mobile communication device in an open position;

FIG. 2 is a top view of the first exemplary embodiment in a closed position;

FIG. 3 is a cross-sectional schematic diagram of the first exemplary embodiment;

FIG. 4 is a top view of a second exemplary embodiment of a mobile communication device in a closed position;

FIG. 5 is a perspective view of a third exemplary embodiment of a mobile communication device in an open position; and

FIG. 6 is a top view of the third exemplary embodiment in a closed position.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Although the apparatus and method described herein may be used with any type of electronic device, the exemplary embodiments are shown herein comprise mobile communication devices. While the mobile communication device is illustrated as a flip-style and a sliding cover cellular telephone, the embodiments can also be implemented in cellular telephones with other housing styles, personal digital assistants, television remote controls, video cassette players, landline telephones, and other electronic devices.

An electronic device is described herein having a display within a housing that allows an operator to provide input to the electronic device by selecting symbols, numbers, and the like on the display for performing one or more tasks. A cover is mechanically coupled to the housing and may be moved to overlie the display. The cover includes an optical element, such as a transparent lenticular material, through which the display may be viewed. The display presents images in two dimensions, and when the cover is “open”, the operator sees the displayed images, for example, diagrams and text, in two dimensions. However, when the cover is “closed”, the operator perceives the images presented through the optical element as three dimensional. This presentation in three dimensions is accomplished with a low cost mechanical structure without electro-optical switching circuitry. The closing of the cover over the display may cause the display to present a predetermined image, for example, a picture, artistic design, or company logo. Although a lenticular material is described in the illustrated exemplary embodiments, other material systems such as a barrier array and a micro-polarized thin film may also be used to provide a three dimensional image.

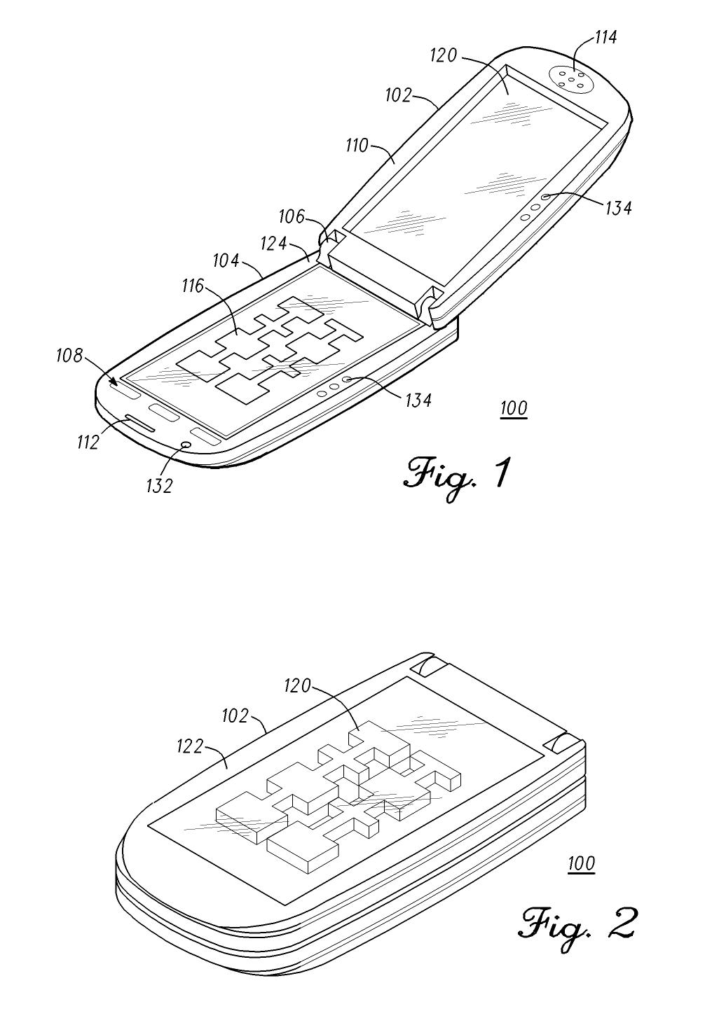

Referring to FIG. 1, the mobile communication device 100 has a first housing 102, or cover, and a second housing 104 movably connected by a hinge 106. The first housing 102 and the second housing 104 pivot between an open position (FIG. 1) and a closed position (FIG. 2). An antenna (not shown) transmits and receives radio frequency (RF) signals for communicating with a complementary communication device such as a cellular base station. Optional function buttons 108 represent, for example, an on/off button, a function button, a handwriting recognition mode button, and a telephone mode button. A microphone 112 receives sound for transmission, and an audio speaker 114, positioned to be accessed on a first side 110 of the housing 102, transmits audio signals to a user.

A display 116 is included in the second housing 104. The display 116 is implemented in this exemplary embodiment as an LCD touchscreen and may display names, telephone numbers, transmitted and received information, user interface commands, scrolled menus, pictures, video, and other information. One image presented on the display 116 includes a standard, twelve-key telephone keypad. Other images may include, for example, a “clear” button, a phonebook mode button, and an “OK” button. Additional or different images, buttons or icons representing modes, and command buttons, pictures, or video can be implemented using the display 116. Each image is a direct driven pixel, and this keyless input device uses a display with aligned optical shutter and backlight cells to selectively reveal one or more images and provide contrast for the revealed images in both low-light and bright-light conditions.

In accordance with the first exemplary embodiment, an optical element 120 is disposed, for example, molded or laminated, within the first housing 102. The optical element 120 allows light to pass therethrough, from the display 116 to a side 122 of the housing 102 (FIG. 2) for viewing. While the display 116 present images in two dimensions, the optical element 120 changes the image viewed therethrough to appear as three dimensional. The optical element 120 is a plurality of lens, preferably made of polymer lenticule, but may also be other types of optical structures, for example, electro-wetting lenses or parallax barriers.

When the mobile communication device 100 is “open” (FIG. 1), the images on the display 116 are viewed as two-dimensional objects. These images may contain three dimensional cues such as shadowing, perspective, occlusion, and size differences. However, they do not contain stereoscopic cues such as different information presented to each eye or motion parallax. These cues, important characteristics of 3-D objects, cannot be presented using standard display technology. When the mobile communication device 100 is “closed” (FIG. 2), the images on the display 116 are viewed through the optical element 120 as three-dimensional objects. This means that the viewer receives stereoscopic cues and/or motion parallax information. An optional sensor 124, for example a push button switch as shown, is activated when the first housing 102 is closed over the second housing 104, causing a predetermined image to be presented on the display 116. Other types of sensors are envisioned in lieu of the switch 124, and may be incorporated into the hinge 124.

An optional sensor 132 may be provided in the second housing and coupled to circuitry that determines when the first housing 102 is in the closed position. This fact may be used to determine an image presented on the display 116. Alternatively, the sensor 132 may be disposed in the first housing 102.

Furthermore, a plurality of registration devices 134 may be disposed on the first and second housings for ensuring alignment of pixels (not shown) within the display 116 with the optical device 120. This alignment in one exemplary embodiment may take the form of merely a mechanical alignment. In another exemplary embodiment, one or more of the alignment devices 134 may be a sensor that detects the precise position of an alignment device on the other of the first or second housing. Input from that sensor is then used to reposition an image on the display 116 to align with the optical device 120.

A simple schematic diagram of the optical element 120 is shown in FIG. 3 as overlying the display 116 in the closed position. The display 116 includes a plurality of LCD pixels 330 arranged in an array of columns and rows (only one column is shown) having a pitch 332 that is determined by the LCD display resolution. The optical element 120, in this exemplary embodiment a lenticular material, includes a transparent polymer material 334 having a thickness equal to a minimum focal length 336, and a plurality of elongate, parallel, lenticular elements 338 having a pitch 340. The lenticular elements 338 are cylindrically converging lenticules (lenses) providing separate images in a known fashion to the eyes 344 of the viewer looking down upon the lenticular elements 338 at a distance 346. “Multiview 3D—LCD”, C. van Berkel, SPIE Proceedings Vol. 2653, pg. 32 and Great Britain patent GB-A-2196166 provide a detailed description of the operation of lenticular devices. In other embodiments, the lenticular lenses have a spherical shape or other geometries.

The pitch 340 is determined so the center of each pixel 330 is projected to the center of the viewing plane 344. The pitch 340 is determined by the equation

l=2i(z−f)/z

where l=pitch 340,

i=pixel 330 pitch,

f=focal length 336, and

z=distance between pixels 330 and viewing plane 342.

Each lenticular element 338 overlies two or more columns of pixels 330 to provide a corresponding number of views. Each lenticular element 338 provides a discrete beam of light from the pixels 330 at an angular direction, which is perceived as a three dimensional image by the viewer.

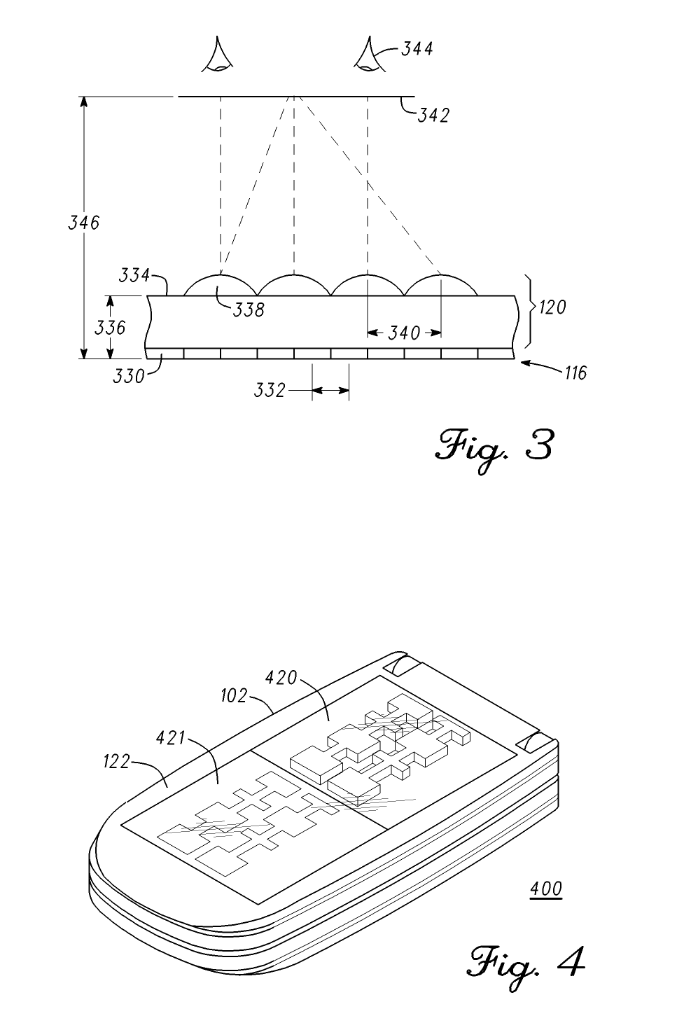

In another exemplary embodiment as shown in FIG. 4, an optical element 420 occupies only a first portion of the housing 102 while a transparent material 421 occupies a second portion. This embodiment allows for the presentation by the display 116 of a three dimensional image viewed through the optical element 420 and a two dimensional image viewed through the transparent material 421. The transparent material 421 preferably is a rigid material such as a polymer or glass.

In order for the lenticular element to provide a three dimensional view, the optical information displayed on the underlying display 116 must be in the correct form for the lens element. Typically, views for the right eye and for the left eye are spatially interlaced in the display 116 pixels. The matching optical element 120 then parses this information appropriately to each eye. In one embodiment, the entire display 116 produces typical 2-D images over the entire display in the “open” flip position. When the flip is “closed” the change in position is detected by a sensor 124, which then changes the information content on at least part of the screen to the spatially interlaced format needed for the three dimensional images.

In order for the spatially-interlaced three dimensional data to display properly through the optical element 120, the optical element must be well-aligned to the display 116 pixels. This can be accomplished by using large lenticular elements that encompass multiple pixels of the display 116, thereby eliminated the sensitivity to alignment. In another embodiment, the flip can be mechanically designed so that the fit is extremely accurate. For example, the flip may align to multiple registration features in the closed state. In still another embodiment, registration features on the flip or optical element may be detected by sensors within the electronic device. These sensors feed data into a processor that shifts the data on the underlying display 116 into proper registration. In another embodiment, data from the sensors could trigger actuators which mechanically tune the position of the flip.

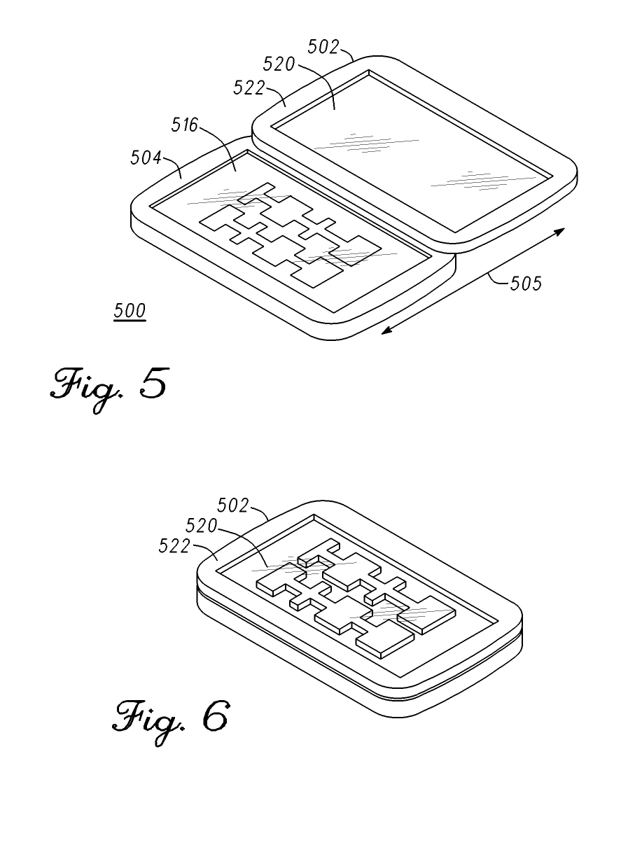

Referring to FIGS. 5 and 6, a third exemplary embodiment illustrates an electronic device 500 having a first housing 502 and a second housing 504. The first housing 502 is moveably mounted to the second housing 504 and may be moved in a direction 505 to an open position as shown by the perspective view in FIG. 5 and a closed position as shown by the top view in FIG. 6. A display 516 is included in the second housing 504. The display 516 is implemented in this exemplary embodiment as a touchscreen. One exemplary image presented on the display 516 includes a standard QWERTY keyboard. Other images may include, for example, a menu and pictures of musicians for which music is being played. Additional or different images, buttons or icons representing modes, and command buttons, or video can be implemented using the display 516. Each image is a direct driven pixel, and this keyless input device uses a display with aligned optical shutter and backlight cells to selectively reveal one or more images and provide contrast for the revealed images in both low-light and bright-light conditions.

In accordance with the third exemplary embodiment, an optical element 520 is positioned in the first housing 502. The optical element 520 allows light to pass therethrough, from the display 516 to a side 522 of the housing 502 (FIG. 6). While the display 516 present images in two dimensions, the optical element 520 changes the image viewed therethrough to appear as three dimensional. The optical element 520 is a plurality of lens, preferably made of polymer lenticule, but may also be other types of optical structures, for example, electro-wetting lenses or parallax barriers.

When the electronic device 500 is “open” (FIG. 5), the images on the display 516 are viewed as two-dimensional objects. When the mobile communication device 500 is “closed” (FIG. 6), the images on the display 516 are viewed through the optical element 520 as three-dimensional objects. An optional switch (not shown) causes a predetermined image to be presented on the display 516 when the electronic device is in the closed position.

Although a lenticular material is described for the optical element 120, 420, 520 in the illustrated exemplary embodiments, other material systems such as a parallax barrier grid or a micro-polarized thin film may also be used to provide a three dimensional image. A parallax barrier grid having transparent and opaque regions can be placed in front of a liquid crystal panel in order for the left eye of an observer can view only the left half of a stereo pair and the right eye of the observer can view only the right half of the stereo pair, resulting in a viewer sensing a three dimensional image. As rays of light pass through several adjacent slits in the parallax barrier grid, a number of additional viewing windows are produced for the left and right views (stereo pair). This technical solution may comprise a number of viewing slits, ranging from a dense grid to a single vertical slit.

The micro-polarized thin film relies on a patterned polarizer and retarder arrays. A different polarization direction is associated with alternating pixels. The stereo data displayed by the LCD module is encoded in the polarization. The micro-polarizer design using polarization is configured to have an auto-stereoscopic mode by using a series of stacked micro-polarizer elements to create a switchable parallax barrier. The design exploits the polarized light output from the LCD module over which is created a patterned retarder film array. A final polarizing layer is placed over the retarder array effectively creating a front parallax barrier and hence a 3D micro-optical element. Linear polarization filters polarize the light horizontally or vertically, wherein light passing through one filter at the display may only pass through the corresponding filter in the closed cover.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. An electronic device comprising:
a housing;
a display positioned within the housing, the display capable of presenting images;
a cover moveably mounted to the housing and capable of assuming an open position and a closed position; and
a optical element disposed within the cover, wherein the display may be viewed directly when the cover is in the open position and wherein at least a portion of the display may be viewed through the optical element when the cover is in the closed position, the optical element converting the images presented on the display into three dimensional images.

2. The electronic device of claim 1 wherein the optical element comprises a lenticular material.

3. The electronic device of claim 1 wherein the optical element comprises a polarized thin film.

4. The electronic device of claim 1 wherein the optical element comprises a parallax barrier grid.

5. The electronic device of claim 1 wherein the cover is mounted to the housing by a hinge.

6. The electronic device of claim 1 wherein the display includes a touch screen and is capable of presenting images and video.

7. The electronic device of claim 1 further comprising a sensor that detects when the cover is in the closed position and that causes a predetermined image to appear on the display.

8. The electronic device of claim 2 wherein the lenticular material comprises a plurality of lenticular elements and the display comprises a plurality of pixels.

9. The electronic device of claim 1 wherein the housing comprises a first plurality of registration features and the cover comprises a second plurality of registration features, wherein the first and second registration features align upon the cover assuming the closed position.

10. The electronic device of claim 1 wherein the electronic device further comprises sensors, and the cover comprises registration features detected by the sensors for aligning the images with the optical element.

11. An electronic device comprising:
a housing;
a display positioned within the housing for presenting images;
a cover moveably mounted to the housing; and
an optical element disposed within the cover, wherein the cover is capable of assuming a first position wherein the display may be viewed directly and assuming a second position wherein the display is viewed through the optical element, thereby giving the images presented on the display a three dimensional appearance.

12. The electronic device of claim 11 wherein the optical element comprises a lenticular material.

13. The electronic device of claim 11 wherein the optical element comprises a polarized thin film.

14. The electronic device of claim 11 wherein the optical element comprises a parallax barrier grid.

15. The electronic device of claim 11 wherein the display includes a touch screen and is capable of presenting images and video.

16. The electronic device of claim 11 further comprising a sensor that detects when the cover is in the closed position and that causes a predetermined image to appear on the display.

17. The electronic device of claim 11 wherein the housing comprises a first plurality of registration features and the cover comprises a second plurality of registration features, wherein the first and second registration features align upon the cover assuming the closed position.

18. The electronic device of claim 11 wherein the electronic device further comprises sensors, and the cover comprises registration features detected by the sensors for aligning the images with the optical element.

19. The electronic device of claim 11 further comprising a transparent portion disposed in the cover wherein a first portion of the display is viewed through the optical element and a second portion of the display is viewed through the transparent portion.

20. A method of displaying images on an electronic device including a display disposed within a housing, and an optical element disposed within a cover, the cover being moveably mounted to the housing, comprising:
moving the cover to a first position wherein a operator may view an image presented by the display; and
moving the cover to a second position wherein the operator may view the image presented on the display through the optical element which converts the image to a three dimensional image.
